(19) United States
(12) Patent Application Publication
(10) Pub. No.: US 2008/0068130 A1
(43) Pub. Date: Mar. 20, 2008

(54) Methods and apparatus for location-dependent disabling of mobile devices

(75) Inventors: Puneet Batta, Santa Clara, CA (US); Ajay Malik, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/515,153

(22) Filed: Aug. 31, 2006

(51) Int. Cl. H04Q 5/22

(52) U.S. Cl. 340/10.1; 340/5.61; 340/10.5; 340/5.74; 455/26.1

(57) ABSTRACT

A handheld device (e.g., an RFID reader, mobile computer, or the like) is configured to periodically scan its environment for the presence of RFID tags, determine whether any of the RFID tags within range include a valid security code, then disable operation (e.g., by preventing access to stored data) when it is determined that there are no RFID tags with a valid security code within the operational range. The RFID tags may be placed strategically at secure locations within the environment, such as within other network devices (access ports, switches, etc.).

### TECHNICAL FIELD

The present invention relates generally to radio frequency identification (RFID) systems, wireless local area networks (WLANs), and any other network incorporating RF elements, and, more particularly, to security systems configured selectively disable mobile devices (e.g., RFID readers, mobile computers, and the like) when such devices are removed from a designated area.

### BACKGROUND

Radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

Mobile devices present particular challenges. Hand-held devices such as RFID readers, laptop computers, PDAs, and the like may be used to acquire sensitive information within a warehouse and other such environment, then removed from the environment. The device and the information stored within the device may thus be stolen and utilized by unauthorized persons. The stored information might include proprietary data, customer lists, etc.

Accordingly, it is desirable to provide a secure, location-dependent method for disabling operation of mobile devices. Other desirable features and characteristics of the present invention will become apparent from the subsequent detailed description and the appended claims, taken in conjunction with the accompanying drawings and the foregoing technical field and background.

### BRIEF SUMMARY

A mobile device (e.g., an RFID reader, mobile computer, or the like) is configured to periodically scan its environment for the presence of RFID tags, determine whether any of the RFID tags within its range include a valid security code, then disable its operation (e.g., by preventing access to stored data) when it is determined that there are no RFID tags with a valid security code within the operational range. The RFID tags may be placed strategically at secure locations within the environment, such as within other network devices (access ports, switches, etc.).

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention; and

FIG. 2 is a conceptual overview of mobile devices at various locations within an environment in which secure RFID tags have been provided.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates to an improved user interface for real-time location determination, configuration, and coordination of RFID as well as WLAN components. The system provides user-friendly methods of determining the location of objects, such as RFID tags and mobile units, and provides various health monitoring information (self-healing status, “heat maps” for associated antennae, redundancy group status, intrusion detection, and health statistics).

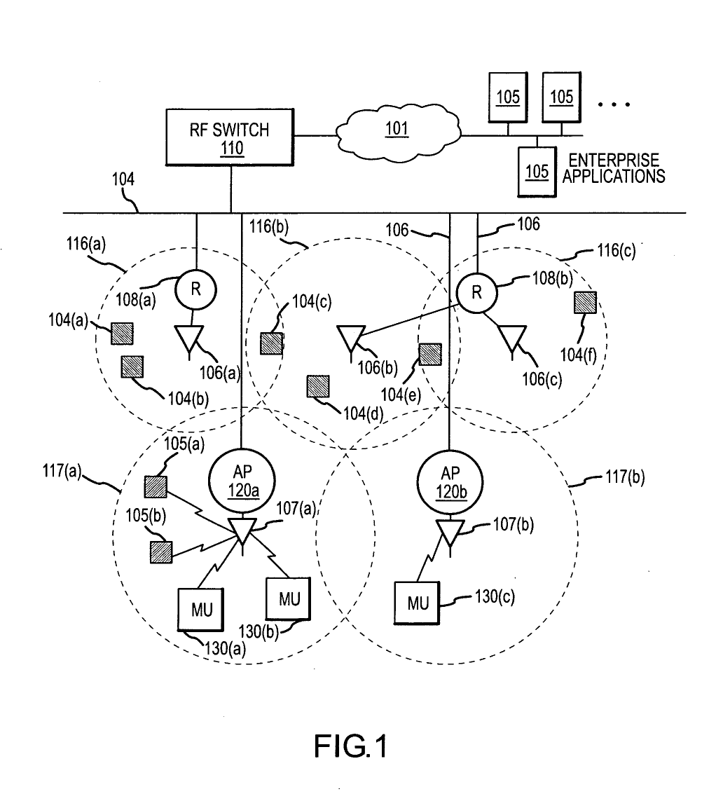

Referring to FIG. 1, in an example system useful in describing the present invention, a switching device 110 (alternatively referred to as an “RF switch” or simply “switch”) is coupled to a networks 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of RFID tags (or simply “tags”) 104 are distributed throughout the environment. These tags are read by a number of RFID readers (or simply “readers”) 108 having one or more associated antennas 106 provided within the environment. The term “tag” refers, in general, to any RF element that can be communicated with and has a ID that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active or passive. Active tags are devices that incorporate some form of power source (e.g., batteries, capacitors, or the like), while passive tags are tags that are energized via an RF energy source received from a nearby antenna. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1).

It is not uncommon for the RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

Switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

Referring to FIG. 1, a system operating in accordance with the present invention generally includes an environment 202—e.g., a store, warehouse, or any other predefined area or volume, which may of course include various doors, windows, and other points of ingress and egress. One or more secure RFID tags 210 are provided within the environment, wherein each of the secure RFID tags includes a predetermined security code that may be read by a mobile device that includes an appropriate RFID reader (e.g., a mobile RFID reader 108 as illustrated).

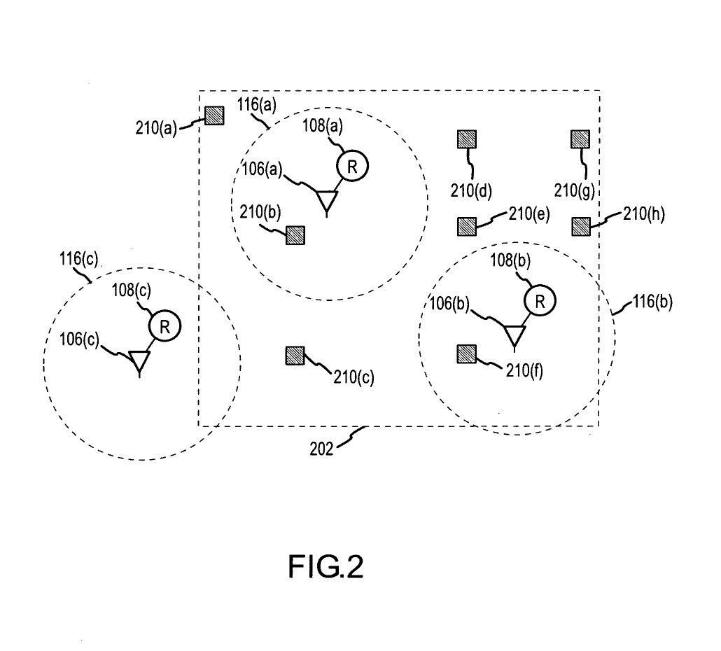

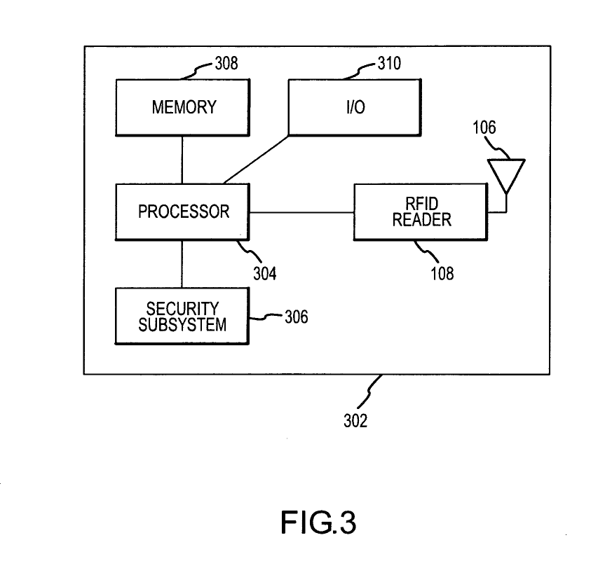

The tags 210 are preferably distributed throughout environment 202 such that at least one of tags 210 is within the operational range of the mobile devices that are used in environment 202. In this regard, it is preferred that tags 210 are substantially stationary (e.g., secured to walls, floors, ceilings, or other internal structures), but in various embodiments may be relocated or portable, depending upon the application. In one embodiment, one or more tags 210 are placed within other electronic components within environment 202, such as wireless switches, routers, access ports, access points, and the like. Tags 210 may be distributed in a uniform, geometrical pattern (e.g., a grid), or may be placed in any suitable non-uniform arrangement that provides the desired coverage (as shown in FIG. 2). The exact positions of tags 210 may be known or unknown.

Tags 210—which may be active or passive—include one or more security codes that may be read by an RFID reader in the conventional matter. These security codes may be of any suitable alphanumeric form, and may be encoded or un-encoded. [Ajay: What do you expect the security code to look like? Do you have any additional details?]. In any event, it is preferred that valid codes are known by the mobile devices—or can be determined by the mobile device (e.g., over a network connection)—so that the mobile device can determine whether it is within or substantially within environment 202.

More particularly, a mobile device operating within environment 202 (e.g., a hand-held RFID reader 108 as illustrated) is configured to read RFID tags within an operational range 116. For the purposes of simplicity, the mobile devices are illustrated as RFID readers 108 in FIG. 2. It will be understood, however, that readers 108 in FIG. 2 may represent any mobile device that includes an RFID reader, including hand-held computers, PDAs, or any other such device.

In this regard, FIG. 3 shows a conceptual block diagram of a mobile device 302 that includes a processor 304, one or more memories 308 (volatile and/or non-volatile), input/output 310 (e.g., display screen, keyboard, pointing device, etc.), a security subsystem 306, and an RFID reader 108 having an antenna 106. Security subsystem 306 interfaces with processor 304 to accomplish the functionality described below. Accordingly, security subsystem 306 includes any suitable combination of hardware, software, and firmware. In one embodiment, security subsystem 306 consists primarily of software code executed by processor 304.

Referring again to FIG. 2, devices 108 are configured to periodically scan environment 202 for the existence of at least one of the secure RFID tags 210 within its operational range 116. This periodic scan may be performed at any suitable rate (e.g., once per second, once per hour, etc.) The security subsystem within a given device 108 is configured to disable operation of the device when it is determined that at least one of the secure RFID tags 210 is not within the operational range of the mobile device—i.e., when it is presumed that the device has been removed from environment 202. Thus, operation of devices 108 is location-dependant.

Device 108 may be disabled if (1) it does not find any tags having a security code within its operational range, or (2) it finds a tag having a security code within its operation range, but that code is not a “valid” code. Device 108 preferably knows, a priori, the set of all valid codes. Alternatively, it may request and receive such codes over the network (e.g., network 104 including RF switch 110, as shown in FIG. 1).

There are three devices 108 illustrated in FIG. 2: 108(a), 108(b), and 108(c). As can be seen, there is one secure tag 210(b) within range of antenna 106(a) associated with device 108(a). Similarly, there is one secure tag 210(f) within range of antenna 106(b) associated with device 108(b). Both of these devices 108(a) and 108(b) would remain operable and enabled. With respect to device 108(c), however, it can be seen that no secure tag 210 is within its operational range 116(c). Consequently, device 108(c) will be disabled.

“Disabling” the mobile device might mean a variety of things, depending upon the application and desired effect. For example, disabling operation of the mobile device might simply involve reducing its functionality—i.e., preventing certain input/output operations. Alternatively, the device might be turned “off” entirely, such that the user cannot power up the device before certain steps have been taken. In one embodiment, the mobile device is disabled such that any information in its memory cannot be read by the operator. This prevents the mobile device from being stolen for the purposes of acquiring stored data.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for secure operation of a mobile device within an environment, wherein the mobile device is configured to read RFID tags within an operational range, the method comprising:
placing a plurality of secure RFID tags within the environment, the secure RFID tags including a predetermined security code;
periodically scanning the environment, via the mobile device, for the existence of at least one of the secure RFID tags within operational range of the mobile device; and
disabling operation of the mobile device when the mobile device determines that at least one of the secure RFID tags is not within the operational range of the mobile device.

2. The method of claim 1, wherein the step of periodically scanning includes reading the predetermined security code and comparing it to a known security code.

3. The method of claim 1, wherein the step of placing the plurality of secure RFID tags includes placing the secure RFID tags such that at least one of the secure RFID tags will be within the operational range of the mobile device when the mobile device is within the environment.

4. The method of claim 3, wherein the secure RFID tags are substantially stationary and at known locations.

5. The method of claim 3, wherein one of the secure RFID tags is placed within a network device.

6. The method of claim 5, wherein one of the secure RFID tags is placed within an access port.

7. The method of claim 1, wherein disabling operation of the mobile device includes reducing functionality of the mobile device.

8. The method of claim 1, wherein disabling operation of the mobile device includes turning the mobile device to an off condition.

9. The method of claim 1, further including enabling the mobile device when at least one of the secure RFID tags is within the operational range of the mobile device.

10. A mobile device comprising:
an RFID reader configured to read RFID tags within an operational range;
a security subsystem configured to instruct the RFID reader to periodically scan for the existence of at least one secure RFID tag within operational range of the mobile device, and place the mobile device in a disabled mode when it is determined that at least one secure RFID tag is not within the operational range of the mobile device.

11. The method of claim 10, wherein the disabled mode includes reducing functionality of the mobile device.

12. The method of claim 10, wherein the disabled mode includes turning the mobile device to an off condition.

13. The method of claim 10, wherein the security subsystem is configured to read a security code included on the secure RFID tag and compare the security code to a set of known codes.

14. The method of claim 10, wherein mobile device includes data stored in a memory, and wherein the security subsystem prevents a user from accessing the data when the mobile device is disabled.

15. A handheld device configured to periodically scan, via an RFID reader, an operational range for the presence of RFID tags, determine whether an RFID tag includes a valid security code, and disable user access to data within a memory when it is determined that there are no RFID tags with a valid security code within the operational range.
